(19) United States
(12) Patent Application Publication
(10) Pub. No.: US 2006/0117869 A1
(43) Pub. Date: Jun. 8, 2006

(54) Method for metering powders and device for implementing the method

(76) Inventors: Thomas Brinz, Bissingen A.D. Teck (DE); Jane Lewis, Stuttgart (DE); Markus Tiefenbacher, Fellbach-Schmiden (DE); Thomas Geiger, Walddorfhaeslach (DE)

Correspondence Address: KENYON & KENYON LLP, ONE BROADWAY, NEW YORK, NY, 10004, US

(21) Appl. No.: 11/241,297

(22) Filed: Sep. 30, 2005

(30) Foreign Application Priority Data
Sep. 30, 2004 (DE) 10 2004 047 464.8

(51) Int. Cl. G01D 7/00

(52) U.S. Cl. 73/862.046

(57) ABSTRACT

A method for metering powders as well as a powder metering device are described which are used in particular for preparing combinatorial material libraries. The powder metering device includes a metering element having a tubular supply vessel open on one end for taking up the powder to be metered and a plunger which is axially movable and which reversibly closes the end of the tubular supply vessel opposite the opening. To take up the powder, the opening of the metering element is first plunged with a predetermined force into a loose fill of the powder to be metered previously charged in a metering receiver.

### FIELD OF THE INVENTION

The present invention relates to a method for metering powders, in particular for the production of combinatorial material libraries and a device for implementing the method.

### BACKGROUND INFORMATION

The discovery and development of new substances and materials is a primary objective of the materials sciences, chemistry, and pharmaceutics. However, the search for suitable compounds is often associated with a great expenditure of time and money. In order to be able to carry out this search more effectively and economically, a systematic method was introduced years ago in pharmaceutics and later in other areas of application, which has become known as “combinatorial chemistry.” In doing so, a number of potentially interesting compounds were produced and analyzed. The advantage of this method is seen in the possibility for automation which allows high throughput in the shortest time.

To produce the material libraries needed for this, for a long time it was necessary to use soluble substances because the only systems that were available for metering substances were those that only allowed the metering of liquids. In materials science in particular, the focus is on the precise metering of for the most part poorly soluble substances in powder or paste form, for example. Furthermore, accurate metering of extremely small quantities of substance increasingly plays a significant role.

A known method for metering powdered substances is to first compress the powder into a pellet which is subsequently penetrated using a suitable hollow punch and the stamped out pellet material is transferred into a vessel for further use. The disadvantage in this method is that it is limited to powders that can be formed into a pellet in a simple manner.

### SUMMARY OF THE INVENTION

An object of the present invention is to provide a powder metering device and a method for operating the same, which allow automated metering of powders in a simple and accordingly cost-effective manner.

The object of the present invention is achieved by a method and a powder metering device.

The powder metering device of the present invention and the method for operating the same have the advantage that automated metering of powders, in particular for the production of combinatorial material libraries, may be performed in a simple and nonetheless reliable manner. In this context, a metering element is used that has a supply vessel open on one end for taking up the substances to be metered, as well as a plunger which reversibly closes the end of the tubular supply vessel opposite the opening, the opening of the supply vessel for receiving the powder being first plunged into a loose fill, of the powder to be metered previously charged in a metering receiver, in such a way that the edges delimiting the opening of the supply vessel contact a bottom surface of the metering receiver. This ensures that a defined quantity of the previously charged powder is taken up into the supply vessel of the metering element.

It is thus an advantage if the metering element is plunged into the previously charged loose fill at least two times, preferably a plurality of times in direct succession since this causes the powder in the supply vessel to be compacted. This causes a compacted and thus defined quantity of the powder to be metered to be formed within the supply vessel. The powder taken up into the supply vessel is advantageously ejected by an axial movement of the plunger. The ejection is preferably made into a metering vessel which is positioned on scales to monitor the metered quantity of powder.

In another advantageous embodiment, the metering element is stripped after the powder is ejected, by pushing it through an elastic, notched and planar stripping element.

In one particularly advantageous embodiment of the present invention, the supply vessel and/or the plunger have a mount as a point of contact for a mechanical grabber. This allows an automatic mounting and operation of the metering element, for example, by a metering robot. Furthermore, the mount may have a coding for detecting the volume or the diameter of the associated supply vessel.

In another particularly advantageous embodiment, the metering receiver includes a vibrator. This causes the layer thickness of the previously charged loose powder fill to be uniform even as the withdrawal progresses. As an alternative or in addition, the metering receiver has side boundary surfaces slanted in the direction of its bottom surface carrying the fill.

### BRIEF DESCRIPTION OF THE DRAWINGS

FIG. 1 shows a schematic flow chart of the method of the present invention including steps A, B and C as well as a cross section of a powder metering device.

FIG. 2 shows a top view of a stripping device.

### DETAILED DESCRIPTION

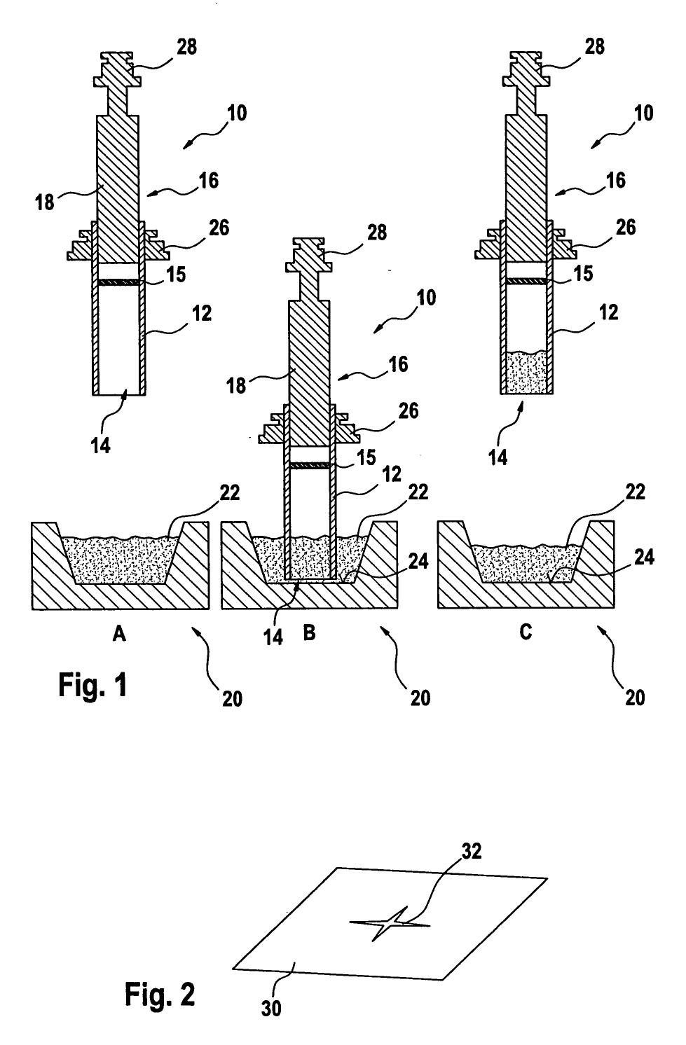

The powder metering device shown in FIG. 1 includes a metering element 10 and a metering receiver 20. Metering element 10 contains a supply vessel 12 for taking up a powder to be metered. Supply vessel 12 is made from an essentially chemically inert material such as glass, PTFE or PVC and preferably has a cylindrical shape. Alternatively, supply vessel 12 may have a round, square, rectangular cross section or a cross section having another geometric shape. Supply vessel 12 is preferably designed to be open on one end, its end diametrically opposed to opening 14 being closed by an axially movable plunger 16. Plunger 16 is preferably designed to be continuously movable in an axial direction because it is thus possible to limit the quantity of powder that may be accommodated in the supply vessel. The continuous adjustability of plunger 16 increases the metering accuracy of metering element 10.

In order to ensure the closability of supply vessel 12 independently of plunger 16, supply vessel 12 preferably has threads, which are not shown, stamped on the outside wall of supply vessel 12, preferably in the area of its opening.

On its end facing the substance to be metered, plunger 16 preferably includes a gasket 15 which is, for example, mechanically affixed and thus designed to be exchangeable. On its side opposite the substance to be metered, plunger 14 merges into a piston rod 18 which preferably has four suitable ribs for better guidance. Plunger 16 and piston rod 18 are preferably made of stainless steel or a chemically inert polymer such as PTFE or PVC.

To ensure automated metering in a short time cycle, a mount or fitting 26, 28 is provided on the end of supply vessel 12 opposite the opening and/or on the side of plunger 16 or piston rod 18 opposite the substance to be metered, the mount or fitting being used as a point of contact for a mechanical grabber which is not shown.

Furthermore, the powder metering device shown in FIG. 1 has a metering receiver 20 which is designed, for example, in the form of a container open at the top into which the powder is introduced as a loose fill 22. Alternatively, the metering receiver is designed as a perforated disc, preferably having a plurality of openings, a movable base plate being provided on the bottom of the perforated disc via which individual or all openings may be closed at the bottom. This makes it possible to place a plurality of different powders in a metering receiver as well as to remove them from the openings after having been picked up by metering element 10 or by rotating or otherwise removing the base plate.

The powder metering device shown in FIG. 1 is used in particular for metering powdered starting compounds for preparing combinatorial material libraries. A powder is understood to be a substance that is present in a solid, predominantly dry and pourable form. Within broad limits, the powder in this connection may have any particle diameter; for example, nanoparticles may also be metered. The powder may be formed from a homogeneous substance or it may contain mixtures of substances.

For metering the powder, metering element 10 is essentially positioned over the opening of metering receiver 20 in a step A, opening 14 of metering element 10 being localized primarily vertically over metering receiver 20. In a step B, metering element 10 is then guided using a predetermined force through the opening of metering receiver 20 in an axial direction in such a way that opening 14 of metering element 10 is plunged into fill 22 until the mechanical resistance caused by fill 22 brings the axial movement to a stop. The level of the predetermined force thus controls the insertion depth. Another possibility is to select the predetermined force to be relatively large and to guide metering element 10 through the opening of metering receiver 20 in an axial direction until opening 14 comes into contact with a bottom surface 24 of metering receiver 20 carrying fill 22.

In doing so, the powder to be metered of fill 22 is pressed into the interior of supply vessel 12. Metering element 10 is then moved upwards in an axial direction, preferably until supply vessel 12 is no longer in contact with fill 22 (step C).

This procedure is preferably repeated a plurality of times until the interior of supply vessel 12 is at least largely filled with the powder to be metered and the powder contained in it is strongly compressed. In a last step, metering element 10 is brought into position over a material receptacle of a combinatorial substrate and the metered powder is ejected by an axial movement of plunger 16. The material receptacle may include, for example, a weighing device for monitoring the quantity of metered powder.

In order to cause the powder to drop down after removal and thus form a new homogeneous fill 22, metering receiver 20 preferably has slanted side walls so that the cross section of metering receiver 20 continuously tapers from this opening in the direction of bottom surface 24. As an alternative or in addition, it is possible to couple metering receiver 20 to a vibration device.

If different powders are metered, the powders may be contaminated if one and the same metering element 10 is used. To avoid a contamination or entrainment of powder adhering to the exterior surface of supply vessel 12, a stripping device 30 may also be provided, as is shown, for example, in FIG. 2. To clean metering element 10, it is guided axially through a preferably cruciform slot 32 of stripping device 30 so that powder adhering to supply vessel 12 is stripped off. The stripping device is preferably designed in a planar form from an elastic material.

For the metering of different powders, an alternative is to assign a separate metering element 10 to each of the powders or powder mixtures to be metered. This effectively prevents the powders from being mixed or contaminated with one another. Should the previously charged powder be an air-sensitive compound, the described metering may be done in a protective gas apparatus, for example, a glove box.

The powder metering device thus includes at least one metering element 10, at least one metering receiver and, if necessary, a grabber, a control unit for controlling the grabber and/or stripping device.

It is possible to provide a plurality of metering elements 10 which differ in particular with respect to the possible metering volume. Despite a different volume of supply vessel 12, the longitudinal dimension of metering elements 10 may be kept largely constant. Different volumes are implemented by the selection of corresponding diameters of supply vessel 12 or by different starting positions of plunger 16 within supply vessel 12. This makes it possible to use metering elements 10 of different metering volumes in succession for metering without the necessity of adapting the mechanical grabber. Furthermore, it is possible to design mounts 26, 28 in such a way that they have an identification marking for identifying the metering volume so that the mechanical grabber is automatically adapted to the corresponding metering volume of the metering element just mounted.

What is claimed is:

1. A method for metering a powder, comprising:
plunging a metering element with an opening thereof and with a predetermined force into a loose fill of the powder to be metered charged in advance in a metering receiver the metering element having a tubular supply vessel open on one end for taking up the powder to be metered and a plunger that is axially movable and that reversibly closes an end of the tubular supply vessel opposite the opening for taking up the powder.

2. The method as recited in claim 1, wherein the supply vessel is plunged in such a way that edges defining the opening of the supply vessel at least approximately contact a bottom surface of the metering receiver.

3. The method as recited in claim 1, further comprising:
transferring the plunging of the metering element at least two times in direct succession to solidify the powder in the supply vessel.

4. The method as recited in claim 1, further comprising:
ejecting the powder taken up into the supply vessel into a metering vessel on scales using the plunger.

5. The method as recited in claim 4, further comprising:
stripping the metering element by pushing the metering element through an elastic, notched, planar element after the powder is ejected.

6. A powder metering device, comprising:
a metering element including a tubular supply vessel having an opening open on one end for taking up a powder to be metered;
a plunger that is axially movable and that reversibly closes an end of the tubular supply vessel opposite the opening;
a metering receiver for containing the powder to be metered in the form of a loose fill, the metering element being designed to be plunged in advance into the loose fill previously charged in the metering receiver.

7. The powder metering device as recited in claim 6, wherein at least one of the supply vessel and the plunger includes a mount as a point of contact for a mechanical grabber.

8. The powder metering device as recited in claim 6, wherein a plurality of metering elements is provided, the supply vessels of which have an essentially identical longitudinal extension and different diameters.

9. The powder metering device as recited in claim 7, wherein the mount has a coding for detecting one of a volume and a diameter of the associated supply vessel.

10. The powder metering device as recited in claim 6, wherein the metering receiver includes a vibrator.

11. The powder metering device as recited in claim 6, wherein the metering receiver has lateral boundary surfaces slanted in a direction of a bottom surface thereof carrying the loose fill.

12. The powder metering device as recited in claim 6, wherein the metering receiver is designed as a perforated disc having a plurality of openings, a movable base plate being provided on the bottom of the perforated disc via which the openings can be closed.

13. The method as recited in claim 1, wherein the method is for preparing a combinatorial material library.
